(19) United States
(12) Patent Application Publication
(10) Pub. No.: US 2013/0091646 A1
(43) Pub. Date: Apr. 18, 2013

(54) Shoe Cleaning Device

(71) Applicant: Jethro Lionel Bennett, London (GB)

(72) Inventor: Jethro Lionel Bennett, London (GB)

(21) Appl. No.: 13/273,005

(22) Filed: Oct. 13, 2011

(30) Foreign Application Priority Data
Oct. 13, 2011 (GB) GB1017367.2

(51) Int. Cl. A47L 23/04; B23P 11/00; A47L 23/08

(52) U.S. Cl. 15/97.2; 15/3; 29/428

(57) ABSTRACT

A shoe cleaning device 10 comprises a rotatable disc 12, a housing 14 on which the disc 12 is rotatably mountable, the housing 14 having a circumference the same, or substantially the same, as the cleaning disc 12, and a motor 16 mounted sideways within the housing 14 to maintain an extreme low profile, the motor 16 remaining within, or substantially within, both a circumference of the housing 14 and of the cleaning disc 12. Preferably the housing 14 encapsulates the motor 16 to form a mounded pinchgrip 38. Preferably a pressure activated unit 62 is provided so that pinching of the pinchgrip 38 activates the device 10, offering an interactive interface for a user. An illuminatory power band 80 may provide variable feedback responses to a user through use of light output, and may also be activated by pressurizing of a pressure activated unit 62. In another embodiment, a motor 16 may be mounted at any angle where there is provided an illuminatory power band 80 for variable feedback response.

The present invention relates to a shoe cleaning device. Shoes need to be polished.

Lack of polishing leads to untidiness, can ruin the look of a shoe, and leads to lessening of the lifespan of a shoe.

A shoe wearer has three choices;

One, they may polish by hand, using the old-fashioned method of a rag/brush and polish. For many, this is considered old-fashioned, a chore, messy, and time consuming.

Two, they may use an electric shoe polisher.

Electric shoe polishers require a significantly sized motor to produce output speeds and torque to adequately shine a shoe. Therefore they are often bulky in size and/or shape. Whichsoever direction the motor is aligned, the device extends significantly in that direction. Some electric shoe polishers attempt to partially by-pass this problem by utilising bristles as the main cleaning element. These create less resistance when shining the shoe and therefore allow for smaller motors and less power/torque. However, bristles are neither highly desirable nor effective for a handheld shoe cleaning device. They have proved in many cases to not shine a shoe well and are not favoured by consumers for electric shoe cleaning devices.

Size, in and of itself, is considered unattractive and creates disinterest in potential users. Users want a device that is small, portable, lightweight, and intuitive. Many devices come in cheap open-side cases, rendering portability impractical or impossible. Furthermore, many are not rechargeable.

The size, shape, and design of the devices often leads to awkward handling. Due to the size and shape, a user cannot grip the device with their fingers alone and adequately apply downward pressure to the surface of a shoe, whilst moving it about the shoe and retaining full control. Many devices require a user hold the device in the palm of a hand, rather than the fingers, which would be more preferable.

Typically, devices have an ON/OFF button to activate rotation of a rotatable cleaning disc. This is not particularly interactive. Furthermore, the devices do not provide variable output responses or innovative features that add value to a user and to the experience of shining a shoe, such as lighting effects or technological features.

For these reasons, electric shoe polishers are seen as even more of a chore, and certainly less effective, than cleaning the shoe with a rag and polish. They have fallen well behind technologies in other personal hygiene and morning cleanliness sectors, such as electric toothbrushes and electric razors, which often have technological features, cutting edge design, and recharging portability aspects. As they have done so, interest in this sector has waned. With large and innovative companies recognising the lack of interest, for the most part only cheap imports remain, bringing with them still further inefficiency, lack of innovation, poor design, such as the use of cheap grey plastic materials and cheap components.

For this reason, many people choose a third option; a portable non-electric sponge applicator, which has a squeezable housing so that a fluid cleaning agent inside may be squeezed onto the sponge and applied to a shoe. The problem is, a sponge applicator often does not shine the shoe. Instead of cleaning and buffing the shoe, it often applies a veneer of fluid agent that covers the surface of the shoe, thus coating it. Over time, this can affect the finish of the shoe, and is not suitable for high quality leather finishes.

The present invention seeks to provide a solution to these problems by providing, in accordance with a first aspect of the invention, a shoe cleaning device comprising a rotatable cleaning disc, a housing on which the cleaning disc is rotatably mountable, the housing having a circumference the same, or substantially the same as the cleaning disc, and a horizontally mounted motor, mounted sideways within the housing to maintain an extreme low profile, the horizontally mounted motor remaining within, or substantially within, both a circumference of the housing and of the cleaning disc.

The sideways mounted motor allows a relatively large motor to be provided, whilst maintaining an extreme low profile. Preferably the housing is approximately only 30 mm high, and may conveniently be less. Normally this would lead to a handle configuration for the housing, extending significantly in a direction the motor is aligned, especially where a pad, rather than bristles, are in use.

Preferably, a non-centrally configured gearbox is provided, non-central to a central axis of the cleaning disc, the gearbox being routed back to a central axis by a preferably bevel gear solution. The device therefore does not extend in any given direction and preferably forms a spinning disc shape, so that all components may be housed in a circular housing that has a substantially similar circumference to the cleaning disc, whilst retaining an extreme low profile.

Preferably the housing tightly encapsulates and surrounds the sideways mounted motor and forms a mounded pinchgrip that may comprise a narrow plain and a scalloped recess each side of the motor. This provides an intuitive means of gripping and control for a user, who can grip the device simply by pinching the mounded pinchgrip and retain full control whilst applying downward pressure and moving over a shoe.

Preferably there is at least one pressure activated unit, which is more preferably activated by pressurizing the pinchgrip, so that a user can activate the device by pinching the grip, preferably between two fingers and a thumb, and with no added movement required, such as switching an ON/OFF button. This adds an intuitive and interactive aspect to the experience of shining a shoe.

Preferably there is provided an illuminatory power band that spans a circumference of the device in totality or pattern. Pinching of the pinchgrip preferably activates the illuminatory power band simultaneously with activating the device. The illuminatory power band provides other variable output responses to the user, such as flashing when recharging is required, lighting in a, preferably circlic and/or cyclic, sequence whilst recharging, and fully illuminating when recharging is complete.

This provides further intuitiveness, an innovative design feature, and adds value to a user, placing the device on a par with modern technology and providing a communicative interface between user and device.

Preferable and/or optional features of the first aspect of the invention are set forth in claims 2 to 11 inclusive.

According to a second aspect of the invention, there is provided a shoe cleaning device comprising a rotatable cleaning disc, a housing on which the cleaning disc is rotatably mountable, a motor housed within the housing, and an illuminatory power band, creating a variable feedback response electric shoe cleaning device.

The motor may be aligned in any given direction.

Preferably there is at least one pressure activated component, so that pinching of a grip activates rotation of the rotatable cleaning disc, and more preferably also activates the illuminatory power band. This adds interactive feedback and value to the experience of shining a shoe, the technological features putting the device on a par with other technological sectors.

Preferable and/or optional features of this aspect of the invention are set forth in claims 13 to 19 inclusive.

According to a third aspect of the invention, there is provided an interactive variable feedback response shoe cleaning system comprising; a storage container, itself comprising a cavity and a lid for closing the cavity; a polish unit container, itself comprising a cavity, a lid or top for closing the cavity, and a cleaning agent within the cavity; at least one selectably interchangeably mountable cleaning disc and/or cleaning element; and a shoe cleaning device, itself comprising, a motor, a housing, a selectably attachable rotatable cleaning disc and/or element; at least one pressure activated unit for activating the device, and an illuminatory power band, wherein all the aforesaid elements are containable within the storage container.

The polish may be a wax, a spray, or any cleaning agent for cleaning a shoe. This aspect of the invention provides the first interactive variable feedback electric shoe polisher and allows a user to easily transport a high-quality shoe cleaning device in a pocket if required. In all cases, the invention favours a pad-based cleaning element, although bristles may be used, most particularly as a brushing disc for cleaning off dirt before an alternate disc for polishing a shoe.

The present invention will now be more particularly described, with reference to the accompanying drawings, by way of example only and in no way limiting the scope of the invention, in which:

FIG. 1 is a perspective view of a preferred embodiment of a shoe cleaning device, in accordance with a first aspect of the invention;

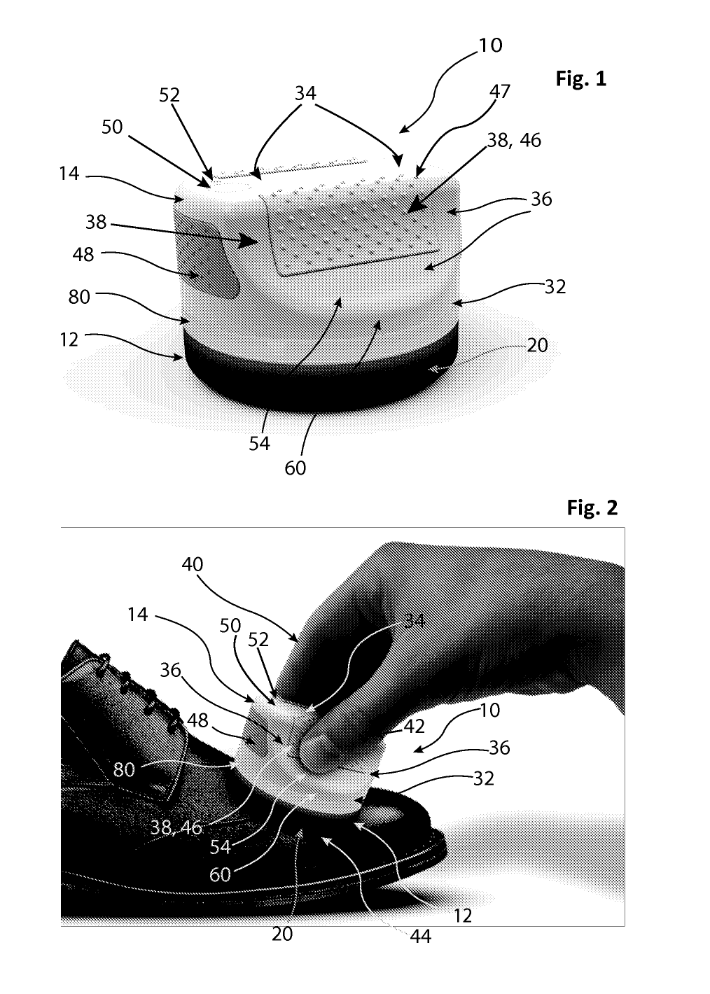

FIG. 2 shows the device in use;

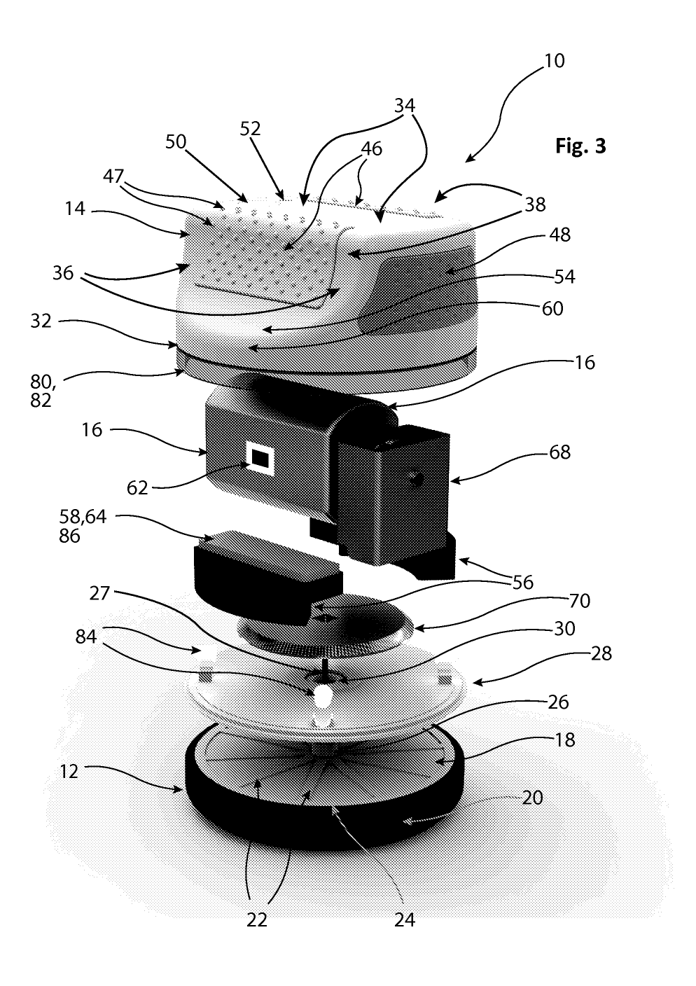

FIG. 3 is an exploded view of the device;

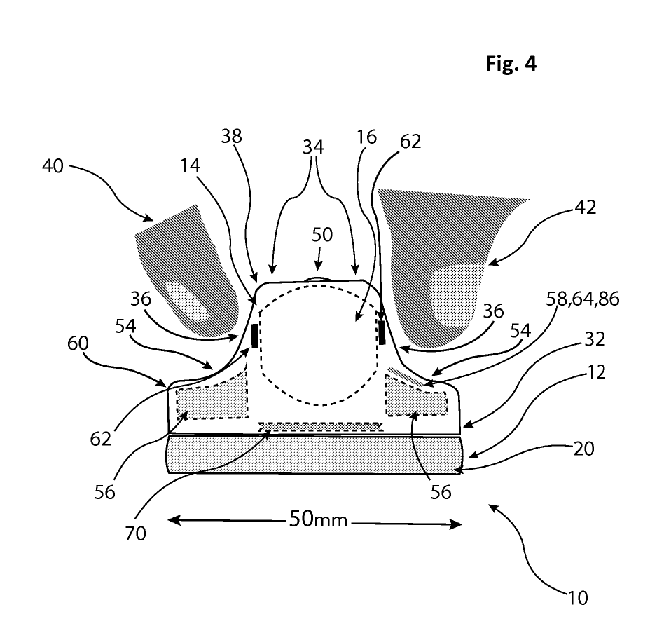

FIG. 4 is a transparented view of the mounded pinchgrip as it is pinched;

FIG. 5 is a transparented view of the sideways mounted motor and non central gear solution in an embodiment where a rim of a housing of the shoe cleaning device is arced;

FIG. 6 is a transparented view of the sideways motor and non central gear solution in an embodiment where a rim of a housing of the shoe cleaning device is rotunded;

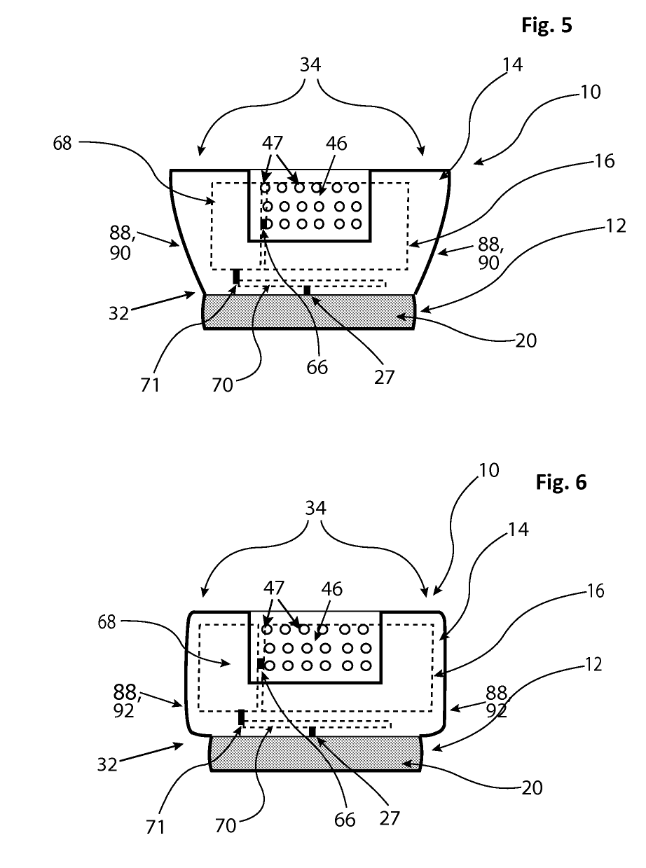

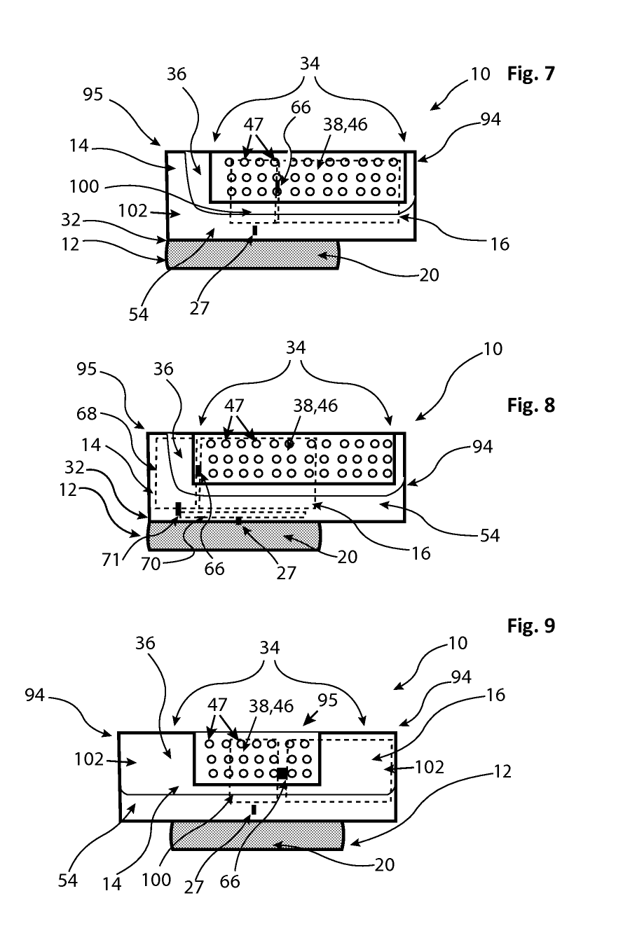

FIG. 7 is a side on transparented view where a protruding butt houses the motor in part or in totality, facilitating a centrally configured gearbox;

FIG. 8 is a side on transparented view of the protruding butt where the sideways mounted motor is substantially within the circlic circumference of the cleaning disc;

FIG. 9 is a side on transparented view where the protruding butt protrudes on both sides of the housing;

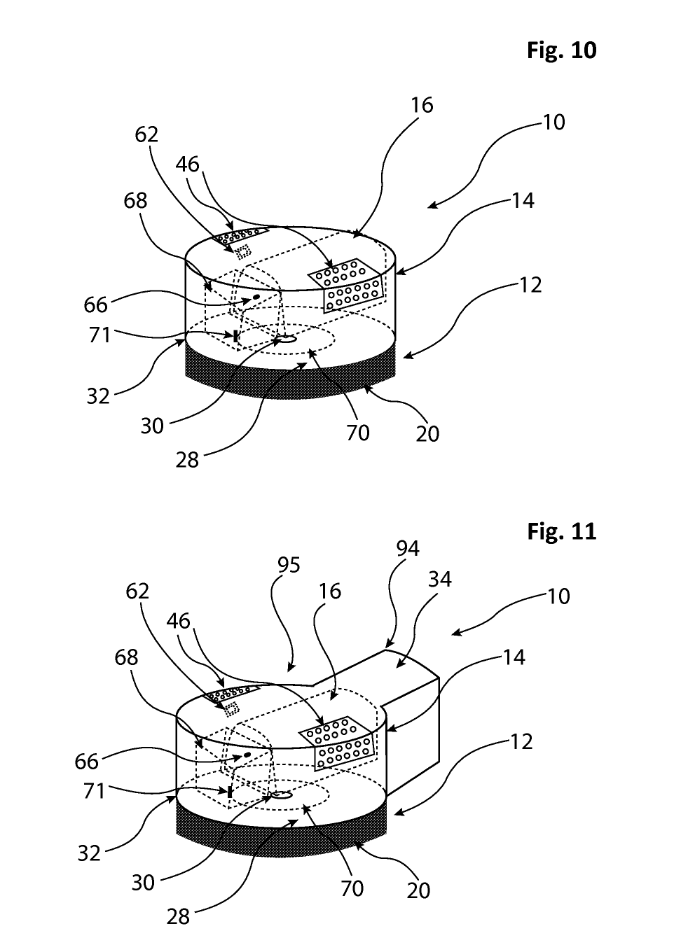

FIG. 10 shows the horizontally mounted motor in a housing with no mounded pinchgrip;

FIG. 11 is a transparented perspective view where a protruding butt provides extra housing space;

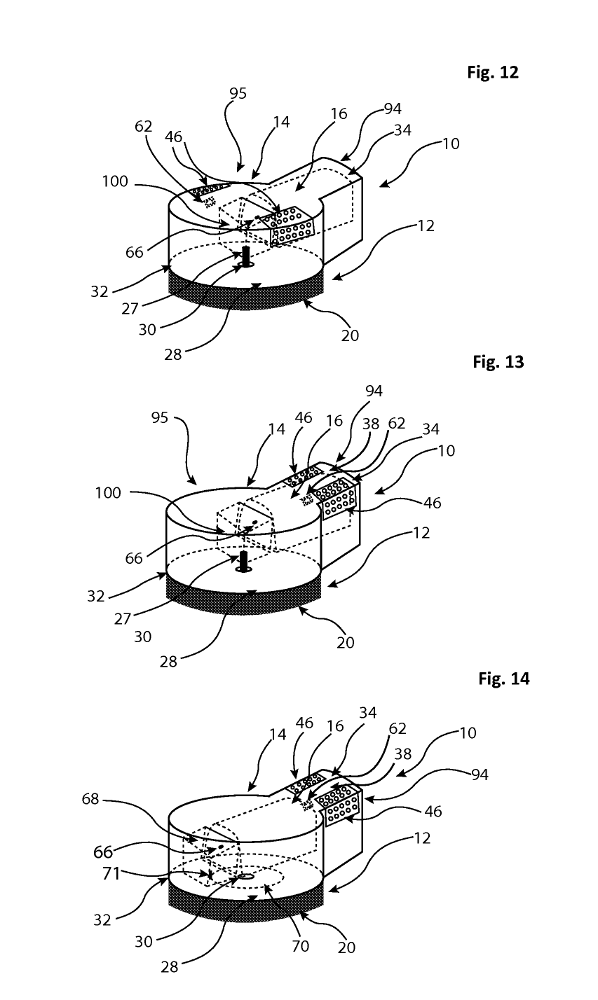

FIG. 12 is a transparented perspective view where the protruding butt houses the motor;

FIG. 13 is a transparented perspective view where the protruding butt forms a pinchgrip;

FIG. 14 is a transparented perspective view where the protruding butt forms a pinchgrip whilst the motor remains housed in a main body of the invention;

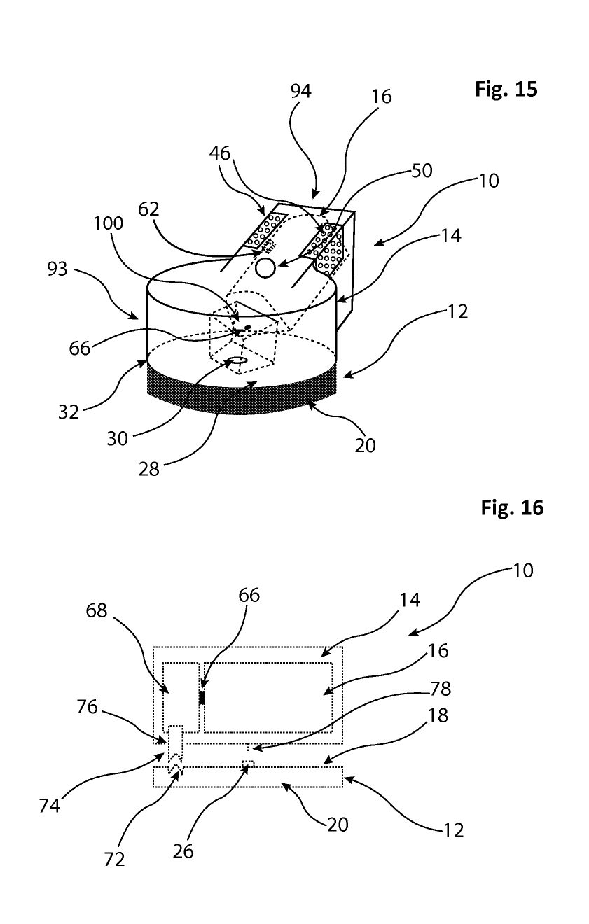

FIG. 15 is a transparented perspective view where the protruding butt protrudes at a non-horizontal angle;

FIG. 16 shows an embodiment of the invention where a non-central gear attaches directly to a disc;

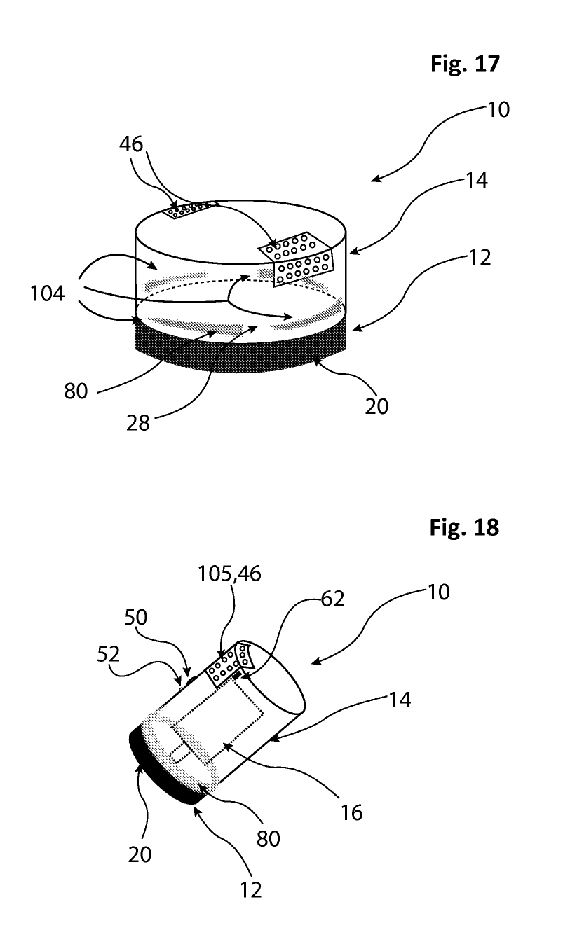

FIG. 17 is a perspective view where an illuminatory power band spans a circumference of the device in pattern;

FIG. 18 is a perspective view of a device in accordance with a second aspect of the invention and shows an illuminatory power band spanning a circumference of the device in totality;

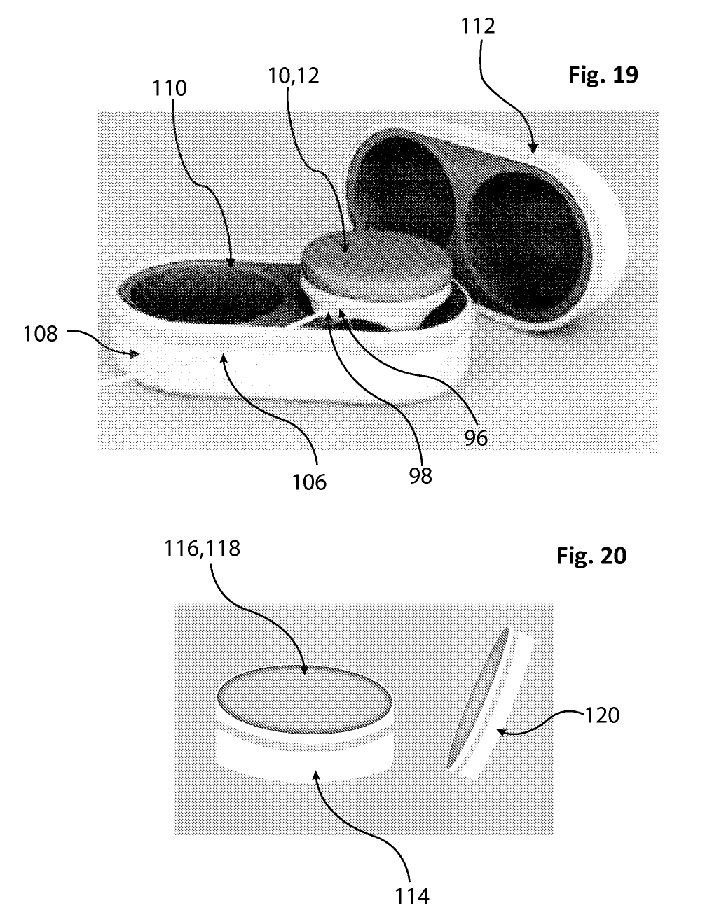

FIG. 19 shows a storage container for the device; and

FIG. 20 shows a polish unit container.

Referring to the drawings, and particularly referring to a preferred embodiment of the invention as depicted in FIG. 1, FIG. 2 and FIG. 3, there is shown a shoe cleaning device 10 which comprises a rotatable cleaning disc 12, a housing 14 on which the cleaning disc 12 is rotatably mountable, the housing 14 having a substantially similar circumference to the cleaning disc 12, and a horizontally mounted motor 16, mounted sideways within the housing 14 to maintain an extreme low profile. Referring to FIG. 1, FIG. 2 and FIG. 3, The horizontally mounted motor 16 remains within, or substantially within, both a circumference of the housing and of the cleaning disc.

The disc 12 has a, typically plastics, base 18 and a cleaning element 20. The base 18 may conveniently include radial spokes 22 that extend to a disc rim 24. The cleaning element 20 may be attached permanently to the, typically plastics, base 18 with resin or glue type materials, or may fit to the base 18 by overlapping the disc rim 24. In this way, it is feasible that a common base 18 may be used for selectable cleaning elements 20, which may reduce cost. In a preferred embodiment a base 18 is singular to each separate cleaning element 20, forming a cleaning disc 12 that is interchangeably selectably mountable.

The disc 12 may be mountable to the housing 14 via a central attachment point 26 that may attach to a central drive shaft 27. The drive shaft 27 may be sheathed or collared as it is received by the central attachment point 26, thus rotating the cleaning disc 12. The disc 12 and/or the cleaning element 20 may be hollowed at its centre to reduce torque as the outer perimeter of a rotating cleaning disc rotates at a higher speed.

The housing 14 has a base 28 that has a central aperture 30. There is shown a circular outer housing rim 32, the housing rim 32 having the same or substantially similar circumference as the disc 12. The housing 14 houses a horizontally mounted motor 16, mounted sideways within the housing to maintain an extreme low profile. The housing 14 may tightly encapsulate the motor 16, thus forming a narrow plain 34 on top of the motor 16 and a scalloped recess 36 on either side of the motor 16. The narrow plain 34 and the scalloped recess 36 together form a mounded pinchgrip 38 that a user may pinch between their fingers 40, or, most preferably, between two fingers 40 and a thumb 42. As shown in FIG. 2, the user may thus pinch the mounded pinchgrip 38, operating the device and simultaneously applying downward pressure to a shoe surface 44.

Preferably on either side of the mounded pinchgrip 38 there is provided a, preferably rubberized, layer of higher friction material 46 or a higher friction surface, which aids gripping of the shoe cleaning device 10. The higher friction material 46 may have pips or projections 47 to further aid gripping of the device 10. A second higher friction material layer 48 or higher friction surface may be provided on opposing ends of the narrow plain 34 so that a user may grip the shoe cleaning device 10 without squeezing the mounded pinchgrip 38.

A depressible booster button 50 is conveniently located on top of the narrow plain 34, and a lighting means 52 beside the booster button 50 indicates its activation. It is feasible that other means of boosting the speed of the rotatable cleaning disc 12 may be provided, such as buttons or switch members, which will be apparent to persons skilled in the art.

The scalloped recess 36 arcuates to a raised housing portion 54, in which various housing components reside, there being housed a, preferably lithium ion rechargeable, battery 56 and a PCB 58. The battery 56 may be present within both raised housing portions 54, either separately offering power to the shoe cleaning device 10 or centrally linked, thus forming one battery unit. Lithium ion battery constitution allows for batteries to be of unorthodox shape. Thus aiding efficiency of the device 10 by maximising the shape and power of a battery 56 to fit within the housing 14.

The raised housing portion 54 conveniently tapers round to the housing rim 32 via an arcuate curve 60.

Pinching of the mounded pinchgrip 38 by a user may activate the motor 16 and therefore the shoe cleaning device 10 via pressure to a pressure activated unit 62 which may conveniently be attached to a side of the motor 16. This is controlled by an activation circuit 64. Differential pressure to the pinchgrip 38 by a user may result in differential speed or power output to the cleaning disc 12.

The horizontally mounted motor 16 has a motor drive shaft 66 which is non-central to a central axis of the cleaning disc 12, thus requiring a non-centrally configured gearbox 68. The gearbox 68 forms a gearing solution that includes a, preferably bevel or crown, gear 70 that routes the axis of rotation back to a central axis, via a non-central geartooth connection 71 thus rotating the rotatable cleaning disc 12. The, preferably bevel or crown, gear 70 may be internal or external to the housing 14.

It is feasible that the cleaning disc base 18 has a gear tooth configuration 72 that receives a, preferably bevel, non-central gear 74 from the non-centrally configured gearbox 68 via a non-central aperture 76 in the housing base 28. In this case, the cleaning disc 12 may be mountable to the housing base 28 via a free spinning axial shaft 78 that may be sheathed or collared, the disc itself acting as a gear.

The housing features an illuminatory power band 80 that may span a circlic circumference of the device 10 and comprises a, preferably plastics, outer screen 82 and multiple LED lights 84 that are controlled by a lighting circuit 86. It is feasible that it may be lighted by other means that will be apparent to those skilled in the art. It may span the circumference of the device 10 in totality or in pattern, and provides variable response outputs to a user, which include being illuminated, being non-illuminated, flashing, and illuminating in a, preferably circlic, sequence.

Referring to FIG. 4 there is shown the shoe cleaning device 10 as the mounded pinch grip 38 is being pinched by a user. At least one pressure activated unit 62 is conveniently attached to the motor 16 so that pressurising of the mounded pinch grip 38 may activate the device 10. The device 10 is approximately 50 mm in diameter, extremely compact for a shoe cleaning device, and more preferably 48 mm. The housing 10 is approximately 30 mm in height, more preferably 27 mm; an extremely compact height, with the cleaning disc 12 preferably being approximately 8 mm in height. In this way, the horizontally mounted motor 16 achieves an extreme low profile for a shoe cleaning device 10, without which the mounded pinchgrip 38 would become unintuitive.

The raised housing portion 54 defines a compartment that includes a lithium ion battery 56 and a PCB 58. The motor 16 drives the cleaning disc 12 via a non-centrally configured gearbox 68, which is not shown in FIG. 4, and a, preferably bevel or crown, gear 70 that is central to a central axis of the cleaning disc 12.

Referring to FIGS. 5 and 6, there is shown a transparented side view of the device 10. The housing rim 32 extends just beyond the circlic circumference of the cleaning disc 12 and retains a substantially similar circumference to the cleaning disc 12. A slight protrusive rim 88 extends from the base of the housing rim 32. In FIG. 5 the protrusive rim 88 tapers to form an arced rim 90. In FIG. 6 the protrusive rim 88 forms a straighter or more rotunded outer edge 92.

The horizontally mounted motor 16 connects to a non-centrally configured gearbox 68 that, via a non-central geartooth connect 71, drives a, preferably bevel or crown, gear 70. The gear 70 has a central output shaft 27 that attaches to the cleaning disc 12, thus rotating it.

In the cases of both FIGS. 5 and 6, and particularly referring to FIG. 6, the sideways mounted motor 16 and non-centrally configured gearbox 68 may partially extend beyond the circlic circumference of the cleaning disc 12. Nonetheless, the housing has a substantially similar circumference or diameter to the cleaning disc, and the sideways mounted motor 16 drives the cleaning disc 12 via a non-centrally configured gearbox 68 and a, preferably bevel or crown, gear 70 that is central to a central axis of the cleaning disc 12. Thus the device 10 retains an extreme low profile. In such an embodiment, the device 10 may appear oblong or rectangular in shape. Preferably the mounded pinchgrip 38 is retained. It is feasible that the mounded pinchgrip 38 may not be retained, although this may increase the girth of the device 10.

Referring to FIGS. 7, 8 and 9, there is provided an embodiment of the invention featuring a protruding butt 94. The protruding butt 94 protrudes from a main body 95 of the housing 14. Preferably the mounded pinchgrip 38 is retained. Thus the protruding butt 94 forms part of the mounded pinchgrip 38, wherein a narrow plain 34 extends on an elongate path from the housing 14.

Referring to FIG. 8, the sideways mounted motor 16 is substantially within the circumference of the cleaning disc 12. The motor 16 drives the cleaning disc 12 via a non-centrally configured gearbox 68 that, via a non-central geartooth connect 71, drives a, preferably bevel or crown, gear 70. The gear 70 has a central output shaft 27 that attaches to the cleaning disc 12, thus rotating it. The central output shaft 27 attaches to a central attachment point 26 of the cleaning disc 12 and may be sheathed or collared.

In this embodiment, the protruding butt 94 may be used to conveniently provide housing space for internal components such as a larger size of battery 56. An input socket 96 for a recharging jack 98 may be conveniently provided on the body of the housing 14 or the protruding butt 94. Referring to FIG. 8, the motor 16 is here shown in alignment with the protruding butt 94, however, the motor 16, in this configuration, may align at any angle within the main body 95 of the housing 14 and may not be in alignment with the protruding butt 94.

Referring to FIGS. 7 and 9, the protruding butt 94 now houses the motor 16 in part or in totality thus facilitating a centrally configured gearbox 100 that is central to a central axis of the cleaning disc 12.

A side compartment 102 of the housing 14 may now provide housing space for internal components such as a larger size of battery 56 or other internal components.

The device 10 now features a centrally configured gearbox 100 and thus does not require a central, preferably bevel or crown, gear 70. Due to the central gear 70 not featuring, this allows for at least one of a furthering of the extreme low profile; a larger motor 16 to be provided in the housing 14; a smaller motor 16 to be provided in the housing 14 that provides equal power output to the cleaning disc 12 due to a greater efficiency of a centrally configured gearbox 100 solution; greater housing space for internal components, such as a larger battery 56 that may provide greater portability to the device 10 by allowing it to function for longer periods without recharging and/or lighting components 84. In the embodiment as featured in FIG. 9, a protruding butt 94 of 15 mm creates a total double side compartment 102 of 30 mm, which allows for greater efficiency or component housing as hereinbefore described. The mounded pinchgrip 38 is preferably retained, thus providing intuitive control to a user. Any or neither protruding butt 94 may form part of a mounded pinchgrip 38.

Referring to FIG. 10, there is shown an embodiment of the invention that features the horizontally mounted motor 16, mounted sideways within the housing 14, the housing having a substantially similar circumference to the cleaning disc 10, thus providing an extreme low profile. The motor 16 drives the cleaning disc 12 via a non-centrally configured gearbox 68 that, via a non-central geartooth connect 71, drives a, preferably bevel or crown, gear 70. The gear 70 has a central output shaft 27 that attaches to the cleaning disc 12, thus rotating it. The central output shaft 27 attaches to a central attachment point 26 of the cleaning disc 12 and may be sheathed or collared.

A, preferably rubberized, higher friction material 46 may conveniently be provided at opposing ends of the housing 14, denoting to a user where to grip and aiding grip therein, whilst providing a makeshift pinchgrip. The pinchgrip may be depressible, thus activating the device 10 via at least one pressure activated unit 62.

Referring to FIGS. 11, 12 and 13, the device 10 features a similar, or the same, circlic housing shape and features a protruding butt 94.

Referring to FIG. 11, a sideways configured motor 16 with a non-centrally configured gearbox 68 is retained, the gearbox 68 driving a centrally configured gear 70. Thus the protruding butt 94 may be used to conveniently provide housing space for internal components such as a larger size of battery 56 as hereinbefore described.

Referring to FIG. 14, the sideways mounted motor 16 and non-centrally configured gearbox 68 are retained. There is now provided higher friction material 46 on the protruding butt 94, which now functions as a mounded pinchgrip 38. The pinchgrip 38, that protrudes from the housing 14, may have a pressure activated unit 62 that may be located within the housing 14, so that a user may pinch the protruding butt 94, thus activating the device 10. Alternatively, a user may hold the protruding butt, wherein there may be located an alternative location on the main body 95 a pressure activated unit 62, so that the protruding butt 94 acts as a pinch grip and the device 10 is otherwise activatable via a pressure activated unit 62. A user may place a finger on top of the circlic housing portion during the act for added stabilisation. The circlic housing portion may provide a booster button and/or switch and any other features as hereinbefore described and aid function of the device 10.

Referring to FIGS. 12 and 13, the protruding butt 94 now provides housing for the motor 16 in part or totality, thereby facilitating a centrally configured gearbox 100. Thus no central, preferably bevel, gear 70 is required, which has benefits as hereinbefore described.

Referring to FIG. 12, a grip remains on a main body 95 of the housing 14 of the device 10. Referring to FIG. 13, the protruding butt 94, features a mounded pinchgrip 38 and higher friction materials 46 or a higher friction surface. The device 10 may feature at least one pressure activated units 62 so that a user may activate the device 10 as hereinbefore described.

Referring to FIG. 15, there is shown an embodiment of the invention where the protruding butt 94 protrudes at a non-horizontal angle. The protruding butt 94 may house the motor 16 in part or wholly, in which case a centrally configured gearing solution may be possible, or the main body 95 of the device 10 may retain the sideways mounted motor 16 with a non-centrally configured gearbox 68, in which case the protruding butt 94 may house other components, or be clear.

The protruding butt 94 may have a pressure activated unit 62 as hereinbefore described, thus the device 10 may be activated by pinching of the protruding butt 94, which becomes a pinchgrip. This may be aided by higher friction materials 46 or a higher friction surface on the protruding butt 94. A pressure activated unit 62 may be present elsewhere on the device 10.

The non-horizontally angled protruding butt 94 may integrally be formed with a mounded pinchgrip 38 from the main body 95 of the housing 14, or, as shown in FIG. 15, may form from a housing that has no mounded pinchgrip 38 on the main body 95. If it is integrally formed with the mounded pinchgrip 38, the rest of the main body 95 may simply be a raised housing portion 54 and be extremely low in height.

As in all embodiments of the invention, there may be provided a booster button 50 that boosts the speed of the rotatable cleaning disc, thus aiding buffing. A lighting element 52 may conveniently be present to denote activation of the booster 50.

In this embodiment of the invention, greater space is required to house the device 10 in a storage container 106, thus harming transportability.

Referring to FIG. 16, there is shown an embodiment of the device 10 which comprises a rotatable cleaning disc 12, a housing 14 on which the cleaning disc 12 is rotatably mountable, the housing 14 having a substantially similar circumference to the cleaning disc 12, and a horizontally mounted motor 16, mounted sideways within the housing 14 to maintain an extreme low profile. The device 10 may feature a mounded pinchgrip 38 or may have a substantially circlic housing shape as hereinbefore described.

The motor 16 connects to a non-centrally configured gearbox 68 but a central gear 70 is foregone in favour of a, preferably bevel, non-central gear 74 that protrudes through a non-central aperture 76 in the housing base 28. The cleaning disc base 18 has a gear tooth configuration 72 that receives the non central gear 74 from the non-centrally configured gearbox 68.

Foregoing the central gear 70 may allow for a furthering of the extreme low profile of the device 10. The cleaning disc 12 acts as an external gear, and attaches to the housing via a free spinning central shaft 78 which may attach to a central attachment point 26 of the disc 12. The free spinning central shaft 78 may be sheathed or collared or of any shape. A disc 12 may be attachable or, in a similar embodiment, a disc 12 may form an integral part of the housing 14, being fixedly attached to the free spinning central shaft 78 and also the non-central gear 74 via a gear tooth configuration 72, so that a separate cleaning disc 12 or cleaning element 20 may be removably clippable and/or attachable to the disc 12.

The non-central gear 74 is preferably bevel, though not limited to being a bevel gear solution, as will be apparent to persons skilled in the art.

Referring to FIGS. 17 and 18, there is provided an illuminatory power band 80 that spans a circlic circumference of the device 10. Referring to FIG. 18, it spans the circumference in totality. Referring to FIG. 17, it spans the circumference in pattern, wherein separate illuminating members 104 are able to light in a sequence, thus performing the function of an illuminatory power band 80 that spans a circlic circumference in totality. In this separate illuminating member 104 configurement, there are preferably at least two illuminating members 104, and more preferably four. It is feasible that one large illuminating member 104 that does not span a circumference of the device 10 may act as a variable feedback illuminatory power band 80, in which case it is of at least 16 mm in dimension, more preferably at least 25 mm. Alternatively a pair or any number of multiple illuminating members and/or strips may be provided.

Particularly if coupled with a pressure activated unit, this creates an interactive variable feedback response electric shoe cleaning device, whereby a user interacts both with the function of the device and/or the illuminatory power band via the pinchgrip. The illuminatory power bands communicates states of the invention, such as use, requirement of charging, via various displays of illumination.

Referring to FIG. 18, there is shown the illuminatory power band 80 where a motor 16 is vertically mounted, thus not requiring a non-centrally configured gearbox 68, the housing 14 forming a tube. An illuminatory power band 80 is provided that spans the circumference of the device 10 in totality, offering variable feedback responses as hereinbefore described. The housing 14 may feature a grip 105, which may conveniently have higher friction materials 46 or a higher friction surface to aid gripping by a user. The device 10 may feature a pressure activated unit 62 so that pressurising of the grip 105 may activate the device, thus activating rotation of the rotatable cleaning disc 12. Preferably the pressurising of the grip 105 also activates the illuminatory power band 80. A booster button 50 or switch member may feature on the housing 14, which may also feature a lighting means 52 which indicates its activation. Downward pressure may be exerted by a user as the device 10 is placed on and moved around a user's shoe. Variations of the embodiment may be provided that will be apparent to persons skilled in the art, such as a pressure activated grip 105 being provided on the top of the housing 14.

The illuminatory power band 80 offers variable feedback responses that significantly add to the intuitiveness of the device 10. As is shown in FIGS. 1 and 2, the illuminatory power band 80 provides illumination when the device 10 is activated, preferably via pinching of a mounded pinchgrip 38 wherein there is a pressure activated unit 62 that may relay an electrical signal to an activation circuit 64 and a lighting circuit 86, or by any other electrical means of lighting a member.

Preferably the illuminatory power band 80 provides further feedback such as flashing during use to indicate the device requires recharging, and separate lighting members 84 and/or illuminating members 104 lighting in a, preferably circlic, sequence to denote when the device 10 is recharging. Referring to FIG. 19, there is provided a recharging jack 98 for an input socket 96. The jack 98 may have a cable 106 so that the device 10 can be recharged via a mains electricity output or any other power output. The device 10 may be wirelessly rechargeable.

There is provided a storage container 108 which comprises a cavity 110, a lid 112 for closing the cavity 110, and a shoe cleaning device 10 substantially as hereinbefore described. The configuration of the container 108 is shown by way of example only. A container 108 may be of similar size to the embodiment here shown, and may have a different cavity 110 configuration, for example multiple cavities 110 to contain multiple shoe cleaning device accessories as well as the device 10.

Referring to FIG. 20, there is provided a polish unit container 114 which comprises a cavity 116, a polishing agent 118 and a lid 120 for closing the cavity, for use with a shoe cleaning device 10 substantially as hereinbefore described. The polishing agent 118 may be a fluid spray. The polish unit container 114 may be a spray container. Preferably the container 114 is of plastics materials and the lid 120 may screw to the base of the container 114, although it may open/close by any method.

In use, the device 10 is picked up via the mounded pinchgrip 38, with a cleaning disc 12 being selected by the user, the cleaning disc 12 being one of a polishing disc, a buffing disc, and a brushing disc. A polishing agent 118 is applied to the cleaning element 20 by the user, although it is feasible a spray polish may be directly sprayed to a shoe. The device 10 may be twisted by the user on contact with the polishing agent 118 so that polish is applied to the disc 12. The device 10 may be gripped at adjacent ends to the mounded pinchgrip 38 preferably via a second higher friction materials 48 that aid gripping of the device 10. This avoids activation of the device 10 which is preferably activated by pinching of the pinchgrip 38.

A polishing disc is selected for polishing, a buffer disc for buffing, preferably after polishing, and a brushing disc is selected to remove dirt and particulate material that may prevent thorough shining of the shoe by the polishing disc. The brushing disc may feature bristles. A sprayer may be provided so that a water based fluid may be sprayed to the shoe to aid cleaning. In this way, a soccer boot, a golf shoe, or a walking boot may be cleaned and may also be prepared for polishing and buffing.

Different colour polishing discs may be provided for different colour polishes and shoes, such as brown or black. The appropriate disc 12 is attached to a central drive shaft 27. The mounded pinchgrip 38 is preferably pinched by two fingers 40 and a thumb 42. Pressure can thus be exerted directly downwards onto a shoe surface 44 as it is placed on and around a user's shoe whilst retaining intuitive and perfect control of the device 10 simply by pinching. If more polishing agent 118 is required, the device 10 may again be pinched by the user at the opposing ends of the mounded pinchgrip 38, aided by the second higher friction material 48 or higher friction surface. Thus the user can easily apply polishing agent 118 during the act.

The selected disc 12 may be unselected and detached by the user by various means that will be apparent to persons skilled in the art, such as unclipping. It may be possible for a disc 12 to be selectably attached by a user simply by applying pressure to it at an angle by which a central drive shaft 27 is received by a central attachment point 26, so that the disc 12 need never be held by the user.

The device 10 is preferably activated by pinching of the mounded pinchgrip 38 by the user, which preferably illuminates an illuminatory power band 80 that spans a circumference of the device 10 in totality or in pattern. The illuminatory power band 80 offers variable feedback responses to the user, illuminating when the device 10 is activated, flashing when the device requires recharging to the battery 56, and lighting in a, preferably circlic, sequence to denote that charging is taking place. It may also alter sequence to denote that charging is complete, thus saving electrical power and/or alerting a user.

An ON/OFF button may feature on the housing 14. Preferably it is not provided as the device 10 is activated by pressure to the mounded pinchgrip 38.

A booster button/switch member 50 may be pressed by the user to generate extra rotational speed for the cleaning disc 12. This may be particularly used for buffing. The combination of the softer buffing disc material, with increased rpm of the cleaning disc 12, and feasibly a fluid spray that is sprayed on to the shoe surface 44 may add shine to the shoe.

After use, the shoe cleaning device is stored in a container 108 which comprises a cavity 110 and a lid 112 for closing the cavity. The container 108 has at least one cavity, which cavities may be used to store at least one selectably mountable discs 12, at least one shoe polish unit container 114 which comprises a cavity 116, a polishing agent 118 and a lid 120 for closing the cavity, and a shoe cleaning device 10 as hereinbefore described. Other accessories may be included. The container 108 closes, and, along with the compactness of the device 10, made possible by the horizontally mounted motor 16, allows full portability of the device 10 with polishing accessories. Preferably the lid 112 clips to the base of the container 108 or is magnetically attachable.

The device 10 is recharged by the user either via a recharging jack 98, or wirelessly, which may activate a relevant lighting sequence from the illuminatory power band 80. Preferably the battery 56 offers at least 10 minutes use when fully recharged, or significantly more, thus ensuring the portability of the device 10.

The sideways mounted motor with a non-centrally configured gearbox creates an extreme low profile and an extremely compact diameter. In an embodiment without the central gear, it may be as low as approximately 25 mm, in a preferred embodiment which comprises the gear, approximately 30 mm.

The mounded pinchgrip offers unparalleled control and interface of the device, allowing a user to pick up the device, apply pressure to a surface, and move the device about a surface whilst retaining complete control of the device, preferably holding with just two fingers and a thumb. The higher friction layer aids grip of the device and enhances it.

The pressure activated unit offers a surprising and interactive interface for the user and further enhances the mounded pinchgrip which, on top of the aforementioned abilities, allows a user to activate the device without the need for an ON/OFF button, further enhancing the intuitiveness and accessibility of the device.

The illuminatory power band offers unparalleled feedback for a shoe cleaning device and enhances the experience by providing a communicative interface.

The device may come in differing colours, such as a black matt plastic finish with a green illuminatory power band or in colours which may be gender specific, such as a white plastic finish with a pink power band.

All features combined, the device offers a unique interface that is personalised, communicative and puts the shoe cleaning device 10 on a par with other technologies in the personal grooming sector.

The device is compact, lightweight and striking, having the appearance of simply being a spinning disc, which is attractive to consumers. This, added to a stylised and close-lid container, and a rechargeable function, makes the device extremely portable, so that a user can easily place the container in a coat pocket, or even in a trouser pocket. The design and technical features mean that, for the first time, a user can proudly shine their shoes with a portable electric shoe cleaning device that is highly efficient, and on a par with modern technology.

Due to the extreme compactness and portability of the device, accessories such as polish unit containers and cleaning discs can be carried in the storage container, whilst retaining portability.

Preferably the polishing unit containers are of plastics materials, remaining lightweight. With the configuration of the opposing ends of the mounded pinchgrip that are not pressure-activated, and preferably have a layer of higher friction material to aid gripping, a user can apply polish without ever being concerned of getting polish on their hands—a key concern to many potential buyers, who perceive shoe shining to be a messy pastime. A clippable attachment means for the discs so that they may easily be selectably mountable, and the reverse, may further enhance efficacy.

The combination of the illuminated power band, the pressure activated unit, the aforementioned technological features, and the compact size and design of the invention creates the first interactive variable feedback response shoe cleaning system, which a user may transport easily via a storage container unit that fits inside a coat or trouser pocket.

The embodiments described above are provided by way of example only, and various modifications will be apparent to persons skilled in the art without departing from the scope of the invention as defined by the appended claims.

1. A shoe cleaning device, comprising;
a rotatable cleaning disc;
a housing on which the cleaning disc is rotatably mountable, the housing having a circumference the same, or substantially the same as the cleaning disc; and
a horizontally mounted motor, mounted sideways within the housing to maintain an extreme low profile, the horizontally mounted motor remaining within, or substantially within, both a circumference of the housing and of the cleaning disc.

2. A shoe cleaning device as claimed in claim 1, wherein there is provided a non-centrally configured gearbox, non-central to a central axis of the cleaning disc.

3. A shoe cleaning device as claimed in claim 2, wherein here is provided a centrally configured gear, central to a central axis of the cleaning disc, that facilitates rotation of the disc via the non-centrally configured gearbox.

4. A shoe cleaning device as claimed in claim 2, wherein there is provided a non-central gear that protrudes through a non-central aperture in a base of the housing, the gear being either;
a) attachable to a gear tooth configuration on a base of the disc, thus rotating the disc, the disc being attachable to a free-spinning central shaft; or
b) attachable to a fixedly attached disc that is an integral part of the housing and rotates about a free-spinning central shaft, so that a cleaning disc and/or cleaning element may be selectably attachable to the fixedlt attached disc, and thus rotatable.

5. A shoe cleaning device as claimed in claim 1, wherein the cleaning disc has a cleaning element that is a pad and is not bristled.

6. A shoe cleaning device as claimed in claim 1 wherein the housing tightly encapsulates and surrounds the sideways mounted motor to form a mounded pinchgrip for gripping between a user's fingers, the mounded pinchgrip comprising a narrow plain on top of the motor and a scalloped recess both sides of the narrow plain for pinching.

7. A shoe cleaning device as claimed in claim 2, wherein the housing tightly encapsulates and surrounds the sideways mounted motor and the non-centrally configured gearbox to form a mounded pinchgrip for gripping between a user's fingers, the mounded pinchgrip comprising a narrow plain on top of the motor and a scalloped recess both sides of the narrow plain for pinching.

8. A shoe cleaning device as claimed in claim 6, wherein the mounded pinchgrip protrudes outside the circumference of the cleaning disc to form a protruding butt, the mounded pinchgrip and/or the protruding butt retaining a narrow plain and a scalloped recess both sides of the narrow plain for pinching.

9. A shoe cleaning device as claimed in claim 1, wherein there is provided at least one pressure activated unit so that pressurizing of a grip activates the device, thus rotating the rotatable cleaning disc.

10. A shoe cleaning device as claimed in claim 6, wherein there is provided a pressure activated unit, located on or about the scalloped recesses of the mounded pinchgrip so that the device is activated by opposing pressure to one or both of the scalloped recesses by a user.

11. A shoe cleaning device as claimed in claim 6, wherein there is provided higher friction materials and/or a higher friction surface on the mounded pinchgrip to aid pinching.

12. Method for creating an interactive variable feedback response shoe cleaning device, comprising;
providing a shoe cleaning device, the device itself comprising
a) a rotatable cleaning disc;
b) a housing on which the cleaning disc is rotatably mountable; and
c) a motor mounted within the housing
and providing an illuminatory power band on the housing of the device that is at least one of;
arranged in pattern;
cyclic;
greater than 16 mm in dimension; and
of multiple illuminating members.

13. Method for creating an interactive variable feedback response shoe cleaning device as claimed in claim 12, wherein the illuminatory power band on the housing of the device is at least three of;
arranged in pattern;
cyclic;
greater than 16 mm in dimension; and
of multiple illuminating members.

14. Method for creating an interactive variable feedback response shoe cleaning device as claimed in claim 12, wherein the illuminatory power band spans a circumference of the device in totality or in pattern.

15. Method for creating an interactive variable feedback response shoe cleaning device as claimed in claim 12, wherein the illuminatory power band offers variable feedback responses to a user, comprising; being fully illuminated, being un-lit, flashing, and lighting in a cyclic sequence.

16. Method for creating an interactive variable feedback response shoe cleaning device as claimed in claim 12, wherein there in provided a pressure activated unit so that pressurizing of a grip activates the device, thus rotating the rotatable cleaning disc.

17. Method for creating an interactive variable feedback response shoe cleaning device as claimed in claim 12, wherein there is provided on the device a booster button and/or switch member to boost speed of the rotatable cleaning disc.

18. Method for creating an interactive variable feedback response shoe cleaning device as claimed in claim 15, wherein pressurizing of the pressure activated unit both activates the device, and also activates the or a illuminatory power band.

19. Method for creating an interactive variable feedback response shoe cleaning device as claimed in claim 12, wherein a plurality of different discs and/or cleaning elements are provided, the discs being selectably interchangeably mountable, and at least one of a polishing disc, a buffing disc, and a brushing disc.

20. An interactive variable feedback response shoe cleaning system, comprising;
a storage container, itself comprising; a cavity and a lid for closing the cavity;
at least one polish unit container, itself comprising; a cavity, a lid or top for closing the cavity, and a polishing agent contained therein;
at least one selectably interchangeably mountable cleaning disc and/or cleaning element; and
a shoe cleaning device, the device comprising;
a motor;
a housing;
a rotatable cleaning disc;
at least one pressure activated unit for activating the device; and
an illuminatory power band;
wherein all the aforesaid elements are containable within the storage container.
